(19) United States
(12) Patent Application Publication
(10) Pub. No.: US 2021/0273947 A1
(43) Pub. Date: Sep. 2, 2021

(54) DEVICES, SYSTEMS, AND METHODS FOR MODIFYING AN ACCESS PERMISSION LEVEL

(71) Applicant: General Electric Company, Schenectady, NY (US)

(72) Inventors: Jeffrey S. Gilton, Cincinnati, OH (US); Brian T. Clark, Cincinnati, OH (US); Douglas R. Nichols, Kentwood, MI (US); Matthew B. Pfenninger, Cincinnati, OH (US)

(73) Assignee: General Electric Company, Schenectady, NY (US)

(21) Appl. No.: 17/062,921

(22) Filed: Oct. 5, 2020

Related U.S. Application Data
(60) Provisional application No. 62/911,527, filed on Oct. 7, 2019.

(51) Int. Cl. H04L 29/06; H04L 9/32; H04L 9/30

(52) U.S. Cl. CPC H04L 63/105; H04L 9/3247; H04L 9/3268; H04L 63/166; H04L 9/30

(57) ABSTRACT

A server device that includes server elements that receive a modification request to modify a respective access permission level, designated to a client device for a target server element, from a baseline permission level among a permission hierarchy of access permission levels to a different permission level among the permission hierarchy. The server device sends a nonce associated with the modification request to the client device, and receives a signed nonce or nonce signature generated by the client device based on the nonce and a client private key of the client device. In response to determining an authenticity of the signed nonce or nonce signature based on a client public key that is associated with the client private key and trusted by the server device, the server device modifies the respective access permission level designated to the client device for the target server element to the requested permission level.

### CROSS-REFERENCE TO RELATED APPLICATION

The present disclosure claims the benefit of priority to U.S. Provisional Application Ser. No. 62/911,527, entitled “DEVICES, SYSTEMS, AND METHODS FOR ESCALATING AN ACCESS PERMISSION LEVEL” and filed on Oct. 7, 2019, the entire contents of which is incorporated by reference herein.

### FIELD

The present disclosure relates to devices, systems, and methods for designating access to a client device for a server element of a server device, and more specifically, to devices, systems, and methods for modifying the designated access permission level to a different permission level in response to verifying an authenticity of a signed nonce or nonce signature generated by the client device.

### BACKGROUND

Aircraft components, particularly aircraft engines, may incorporate a plurality of sensors that sense various conditions relating to the aircraft components, which are used by software programs to detect, diagnose, or predict issues and/or faults in real time, even as the aircraft is being operated (e.g., flying). Such software programming is frequently updated as more information regarding operation of aircraft components is obtained such that the software becomes more accurate in diagnosing or predicting issues and/or faults with each successive update.

Software updates may be pushed to the aircraft by diagnostic devices authenticated with the aircraft. However, existing authentication mechanisms are based on respective passwords for each diagnostic device attempting to authenticate with the aircraft, and managing passwords for numerous diagnostic device can be time consuming. Accordingly, a need exists for an authentication mechanism that does not require managing numerous passwords.

### SUMMARY

In an embodiment, a method for modifying an access permission level is carried out by a server device that includes one or more server elements. The method includes receiving a modification request from a client device to modify a respective access permission level, designated to the client device for a target server element among the server elements, from a baseline permission level among a permission hierarchy of access permission levels to a different permission level among the permission hierarchy. The method further includes sending a nonce associated with the modification request to the client device, and receiving a signed nonce or nonce signature generated by the client device based on both the nonce and a client private key of the client device. The method also includes making a signature verification determination of an authenticity of the received signed nonce or nonce signature based on a client public key that is both associated with the client private key and trusted by the server device. Additionally, the method includes making an authorization determination that the client device is authorized for the requested permission level for the target server element. The method further includes, in response to making both the signature verification determination and the authorization determination, modifying the respective access permission level designated to the client device for the target server element from the baseline permission level to the requested permission level.

In an embodiment, a server device includes one or more server elements, a processor, and a non-transitory computer-readable storage medium that includes instructions and data. The instructions, when executed by the processor, cause the server device to receive a modification request from a client device to modify a respective access permission level, designated to the client device for a target server element among the server elements, from a baseline permission level among a permission hierarchy of access permission levels to a different permission level among the permission hierarchy. The instructions further cause the server device to send a nonce associated with the modification request to the client device, and receive a signed nonce or nonce signature generated by the client device based on both the nonce and a client private key of the client device. The instructions also cause the server device to make a signature verification determination of an authenticity of the received signed nonce or nonce signature based on a client public key that is both associated with the client private key and trusted by the server device. Additionally, the instructions cause the server device to make an authorization determination that the client device is authorized for the requested permission level for the target server element. The instructions further cause the server device to, in response to making both the signature verification determination and the authorization determination, modify the respective access permission level designated to the client device for the target server element from the baseline permission level to the requested permission level.

In an embodiment, a method for modifying an access permission level is carried out by a server device that includes one or more server elements. The method includes establishing a communication session with a client device. The method further includes receiving, via the communication session, a modification request from a client device to modify a respective access permission level, designated to the client device for a target server element among the server elements, from a baseline permission level among a permission hierarchy of access permission levels to a different permission level among the permission hierarchy. The method further includes sending a nonce associated with the modification request to the client device, and receiving a signed nonce or nonce signature generated by the client device based on both the nonce and a client private key of the client device. The method also includes making a signature verification determination of an authenticity of the received signed nonce or nonce signature based on a client public key that is both associated with the client private key and trusted by the server device. Additionally, the method includes making an authorization determination that the client device is authorized for the requested permission level for the target server element. The method further includes, in response to making both the signature verification determination and the authorization determination, modifying the respective access permission level designated to the client device for the target server element from the baseline permission level to the requested permission level. The method includes receiving, from the client device, an operation request to perform a given operation on the target server device, and making a permission determination that the respective access permission level designated to the client device for the target server element is no less than a required permission level for performing the given operation on the target server device. The method additionally includes, in response to making the permission determination, allowing performance of the given operation on the target server device.

These and other features, and characteristics of the present technology, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of ‘a’, ‘an’, and ‘the’ include plural referents unless the context clearly dictates otherwise.

### BRIEF DESCRIPTION OF THE DRAWINGS

FIG. 1 depicts an example access control system, according to one or more embodiments shown and described herein;

FIG. 2a depicts a block diagram of a server device, according to one or more embodiments shown and described herein;

FIG. 2b depicts a block diagram of a client device, according to one or more embodiments shown and described herein;

FIG. 3 depicts a flowchart of a method carried out by a server device, according to one or more embodiments shown and described herein;

FIG. 4 depicts a permission hierarchy of access permission levels, according to one or more embodiments shown and described herein; and

FIG. 5 depicts a designated permission table, according to one or more embodiments shown and described herein.

### DETAILED DESCRIPTION

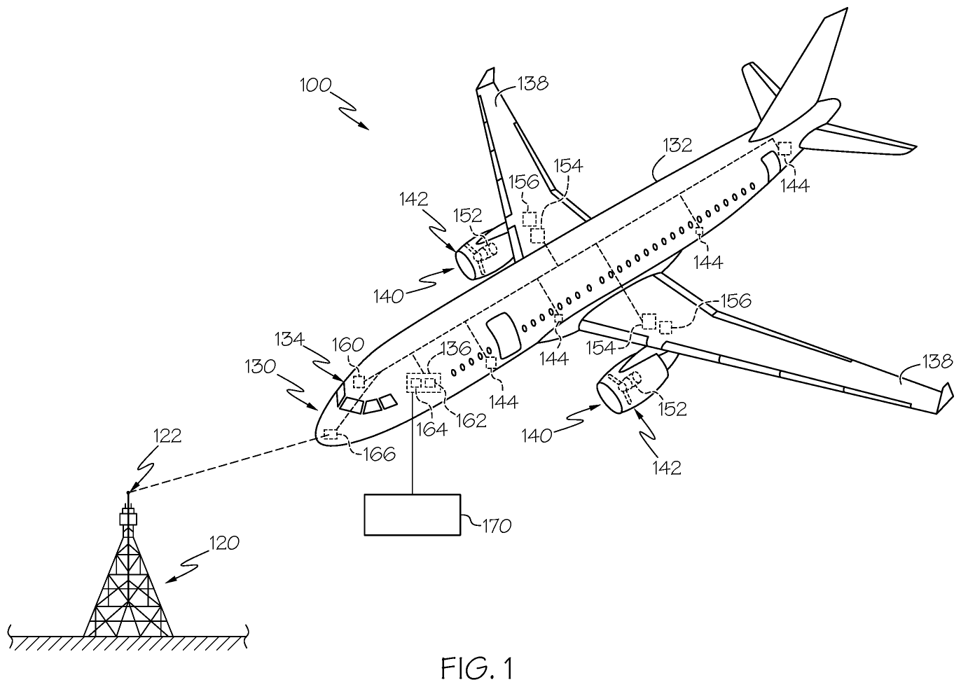

FIG. 1 depicts an example access control system, according to one or more embodiments shown and described herein. As shown, an access control system 100 generally contains an interconnectivity of components coupled via a network, which may include a wide area network, such as the internet, a local area network (LAN), a mobile communications network, a public service telephone network (PSTN) and/or other network and may be configured to electronically connect components. The illustrative components that may be connected via the network include, but are not limited to, a ground system 120 in communication with the aircraft 130 (e.g., via a ground wireless communications link 122 and an aircraft wireless communications link 166), and a ground support equipment (GSE) 170.

The aircraft 130 generally includes a fuselage 132, wing assemblies 138, and one or more engines 140. As shown in FIG. 1, the wing assemblies 138 may extend outward from fuselage 132, and engines 140 may be coupled to the wing assemblies 138 and/or the fuselage 132. Though FIG. 1 depicts the aircraft 130 as being a fixed-wing craft having two wing assemblies 138 with a respective engine 140 mounted on each of the wing assemblies 138 (two engines 140 total), other configurations are contemplated. For example, other configurations may include more than two wing assemblies 138, more than two engines 140 (e.g., trijets, quadjets, etc.), engines 140 that are not mounted to any of the respective wing assemblies 138 (e.g., mounted to the fuselage, mounted to the tail, mounted to the nose, etc.), non-fixed wings (e.g., rotary wing aircraft), and/or the like.

Aircraft 130 may further include a cockpit 134 positioned in the fuselage 132, a plurality of additional aircraft systems 144, a communication system having the aircraft wireless communications link 166, and an engine control system 136.

The cockpit 134 may include a control mechanism 160 for controlling the aircraft 130 and which may be operated by a pilot located in the cockpit 134. It should be understood that the term “control mechanism” as used herein is a general term used to encompass all aircraft control components, particularly those typically found in the cockpit 134.

The additional aircraft systems 144 may generally be any systems that effect control of one or more components of the aircraft 130, such as, for example, cabin pressure controls, elevator controls, rudder controls, flap controls, spoiler controls, landing gear controls, heat exchanger controls, and/or the like. In some embodiments, the avionics of the aircraft 130 may be encompassed by one or more of the additional aircraft systems 144.

The aircraft wireless communications link 166 may generally be any air-to-ground communication system now known or later developed. Illustrative examples of the aircraft wireless communications link 166 include, but are not limited to, a transponder, a very high frequency (VHF) communication system, an aircraft communications addressing and reporting system (ACARS), a controller-pilot data link communications (CPDLC) system, a future air navigation system (FANS), and/or the like.

The engine control system 136 may be operably coupled to the plurality of aircraft systems 144 and/or the engines 140. While the embodiment depicted in FIG. 1 specifically refers to the engine control system 136, it should be understood that other controllers may also be included within the aircraft 130 to control various other aircraft systems 144 that do not specifically relate to the engines 140.

The engine control system 136 generally includes one or more components for controlling each of the engines 140, such as, for example, a diagnostic computer, an engine-related digital electronic unit that is mounted on one or more of the engines 140 or the aircraft 130, and/or the like. The engine control system 136 may also be referred to as a digital engine control system. Illustrative other components within the engine control system that may function with the engine control system 136 and may require software to operate include, but are not limited to, an electronic engine control (EEC), an electronic engine control unit (EECU), a distributed control module (DCM), a digital engine control (DEC), an engine monitoring unit (EMU), and an engine monitoring system (EMSC). The software used by any one of these components may be software that is distributed as described herein

The engine control system 136 may also be connected with other controllers of the aircraft 130. In embodiments, the engine control system 136 may include a processor 162 and/or a non-transitory memory component 164, including non-transitory memory. In some embodiments, the non-transitory memory component 164 may include random access memory (RAM), read-only memory (ROM), flash memory, or one or more different types of portable electronic memory, such as discs, digital versatile discs (DVDs), compact disc read-only memories (CD-ROMs), or the like, or any suitable combination of these types of memory. The processor 162 may carry out one or more programming instructions stored on the non-transitory memory component 164, thereby causing operation of the engine control system 136. That is, the processor 162 and the non-transitory memory component 164 within the engine control system 136 may be operable to carry out the various processes described herein with respect to the engine control system 136, including operating various components of the aircraft 130 (such as the engine 140 and/or components thereof), monitoring the health of various components of the aircraft 130 (e.g., the engine 140 and/or components thereof), monitoring operation of the aircraft 130 and/or components thereof, installing software, installing software updates, modifying a record in a distributed ledger to indicate that software has been installed, and/or updated, carrying out processes according to installed and/or updated software, and/or the like.

In some embodiments, the engine control system 136 may include a full authority digital engine control (FADEC) system. Such a FADEC system can include various electronic components, one or more sensors, and/or one or more actuators that control each of the engines 140. In particular embodiments, the FADEC system includes an EEC or EECU, as well as one or more additional components that are configured to control various aspects of performance of the engines 140. The FADEC system generally has full authority over operating parameters of the engines 140 and cannot be manually overridden. A FADEC system generally functions by receiving a plurality of input variables of a current flight condition, including, but not limited to, air density, throttle lever position, engine temperature, engine pressure, and/or the like. The inputs are received, analyzed, and used to determine operating parameters such as, but not limited to, fuel flow, stator vane position, bleed valve position, and/or the like. The FADEC system may also control a start or a restart of the engines 140. The operating parameters of the FADEC can be modified by installing and/or updating software, such as the software that is distributed by the access control system 100 described herein. As such, the FADEC can be programmatically controlled to determine engine limitations, receive engine health reports, receive engine maintenance reports and/or the like to undertake certain measures and/or actions in certain conditions.

In some embodiments, the engine control system 136 may include a Prognostics and Health Monitoring (PHM) system. Such a PHM system can include various electronic components, one or more sensors, and/or one or more actuators that monitor one or more engine systems in the aircraft 130. In some embodiments, the PHM system may be used to predict a future performance of a component by assessing an extent of deviation and/or degradation of a system from its expected normal operating conditions. This may be completed by analyzing failure modes, detecting early signs of wear and aging, and detecting fault conditions. Such actions may be data driven, and may be improved by utilizing machine learning or the like to more accurately predict conditions and determine potential faults. As such, software that is implemented by the PHM system may be continuously updated via the systems and methods described herein to cause the PHM system to more accurately sense and predict component performance.

In some embodiments, the engine control system 136 may include one or more programming instructions for diagnosing and/or predicting one or more engine system faults in the aircraft 130. Diagnosed and/or predicted faults may include, but are not limited to, improper operation of components, failure of components, indicators of future failure of components, and/or the like. As used herein, the term diagnosing refers to a determination after the fault has occurred and contrasts with prediction, which refers to a forward looking determination that makes the fault known in advance of when the fault occurs. Along with diagnosing, the engine control system 136 may detect the fault.

The software run by the engine control system 136 (e.g., executed by the processor 162 and stored within the non-transitory memory component 164) may include a computer program product that includes machine-readable media for carrying or having machine-executable instructions or data structures. Such machine-readable media may be any available media, which can be accessed by a general purpose or special purpose computer or other machine with a processor. Generally, such a computer program may include routines, programs, objects, components, data structures, algorithms, and/or the like that have the technical effect of performing particular tasks or implementing particular abstract data types. Machine-executable instructions, associated data structures, and programs represent examples of program code for executing the exchange of information as disclosed herein. Machine-executable instructions may include, for example, instructions and data, which cause a general purpose computer, special purpose computer, or special purpose processing machine to perform a certain function or group of functions.

In some embodiments, the computer program product may be provided by a component external to the engine control system 136 and installed for use by the engine control system 136. For example, the computer program product may be provided by the GSE 170, as described in greater detail herein. The computer program product may generally be updatable via a software update that is received from one or more components of the access control system 100, such as, for example, the GSE 170, as described in greater detail herein. The software is generally updated by the engine control system 136 by installing the update such that the update supplements and/or overwrites one or more portions of the existing program code for the computer program product. The software update may allow the computer program product to more accurately diagnose and/or predict faults, provide additional functionality not originally offered, and/or the like.

In embodiments, each of the engines 140 may include a fan 142 and one or more sensors for sensing various characteristics of the fan 142 during operation of the engines 140. Illustrative examples of the one or more sensors include, but are not limited to, a fan speed sensor 152, a temperature sensor 154, and a pressure sensor 156. The fan speed sensor 152 is generally a sensor that measures a rotational speed of the fan 142 within the engine 140. The temperature sensor 154 may be a sensor that measures a fluid temperature within the engine 140 (e.g., an engine air temperature), a temperature of fluid (e.g., air) at an engine intake location, a temperature of fluid (e.g., air) within a compressor, a temperature of fluid (e.g., air) within a turbine, a temperature of fluid (e.g., air) within a combustion chamber, a temperature of fluid (e.g., air) at an engine exhaust location, a temperature of cooling fluids and/or heating fluids used in heat exchangers in or around an engine, and/or the like. The pressure sensor 156 may be a sensor that measures a fluid pressure (e.g., air pressure) in various locations in and/or around the engine 140, such as, for example, a fluid pressure (e.g., air pressure) at an engine intake, a fluid pressure (e.g., air pressure) within a compressor, a fluid pressure (e.g., air pressure) within a turbine, a fluid pressure (e.g., air pressure) within a combustion chamber, a fluid pressure (e.g., air pressure) at an engine exhaust location, and/or the like.

In some embodiments, each of the engines 140 may have a plurality of sensors associated therewith (including one or more fan speed sensors 152, one or more temperature sensors 154, and/or one or more pressure sensors 156). That is, more than one of the same type of sensor may be used to sense characteristics of an engine 140 (e.g., a sensor for each of the different areas of the same engine 140). In some embodiments, one or more of the sensors may be utilized to sense characteristics of more than one of the engines 140 (e.g., a single sensor may be used to sense characteristics of two engines 140). The engines 140 may further include additional components not specifically described herein, and may include one or more additional sensors incorporated with or configured to sense such additional components in some embodiments.

In embodiments, each of the sensors (including, but not limited to, the fan speed sensors 152, the temperature sensors 154, and the pressure sensors 156) may be communicatively coupled to one or more components of the aircraft 130 such that signals and/or data pertaining to one or more sensed characteristics are transmitted from the sensors for the purposes of determining, detecting, and/or predicting a fault, as well as completing one or more other actions in accordance with software that requires sensor information. As indicated by the dashed lines extending between the various sensors (e.g., the fan speed sensors 152, the temperature sensors 154, and the pressure sensors 156) and the aircraft systems 144 and the engine control system 136 in the embodiment depicted in FIG. 1, the various sensors may be communicatively coupled to the aircraft systems 144 and/or the engine control system 136 in some embodiments. As such, the various sensors may be communicatively coupled via wires or wirelessly to the aircraft systems 144 and/or the engine control system 136 to transmit signals and/or data to the aircraft systems 144 and/or the engine control system 136.

It should be understood that the aircraft 130 merely represents one illustrative embodiment that may be configured to implement embodiments or portions of embodiments of the devices, systems, and methods described herein. During operation, the aircraft 130 (such as the engine control system 136 and/or another component) may diagnose or predict a system fault in one or more of the various aircraft systems 144. By way of non-limiting example, while the aircraft 130 is being operated, the control mechanism 160 may be utilized to operate one or more of the aircraft systems 144. Various sensors, including, but not limited to, the fan speed sensors 152, the temperature sensors 154, and/or the pressure sensors 156 may output data relevant to various characteristics of the engine 140 and/or the other aircraft systems 144. The engine control system 136 may utilize inputs from the control mechanism 160, the fan speed sensors 152, the temperature sensors 154, the pressure sensors 156, the various aircraft systems 144, one or more database, and/or information from airline control, flight operations, or the like to diagnose, detect, and/or predict faults that airline maintenance crew may be unaware of. Among other things, the engine control system 136 may analyze the data output by the various sensors (e.g., the fan speed sensors 152, the temperature sensors 154, the pressure sensors 156, etc.), over a period of time to determine drifts, trends, steps, or spikes in the operation of the engines 140 and/or the various other aircraft systems 144. The engine control system 136 may also analyze the system data to determine historic pressures, historic temperatures, pressure differences between the plurality of engines 140 on the aircraft 130, temperature differences between the plurality of engines 140 on the aircraft 130, and/or the like, and to diagnose, detect, and/or predict faults in the engines 140 and/or the various other aircraft systems 144 based thereon. Once a fault has been diagnosed, detected, and/or predicted, an indication may be provided on the aircraft 130 and/or at the ground system 120. It is contemplated that the diagnosis, detection, and/or prediction of faults may be completed during pre-flight checks, may be completed during flight, may be completed post flight, or may be completed after a plurality of flights has occurred. The aircraft wireless communications link 166 and the ground wireless communications link 122 may transmit data such that data and/or information pertaining to the fault may be transmitted off the aircraft 130.

While the embodiment of FIG. 1 specifically relates to components within an aircraft 130, the present disclosure is not limited to such. That is, the various components depicted with respect to the aircraft 130 may be incorporated within various other types of craft and may function in a similar manner to deliver and install new software and/or updated software to the engine control system 136 as described herein. For example, the various components described herein with respect to the aircraft 130 may be present in watercraft, spacecraft, and/or the like without departing from the scope of the present disclosure.

Still referring to FIG. 1, the ground system 120 is generally a transmission system located on the ground that is capable of transmitting and/or receiving signals to/from the aircraft 130. That is, the ground system 120 may include a ground wireless communications link 122 that is communicatively coupled to the aircraft wireless communications link 166 wirelessly to transmit and/or receive signals and/or data. In some embodiments, the ground system 120 may be an air traffic control (ATC) tower and/or one or more components or systems thereof. Accordingly, the ground wireless communications link 122 may be a VHF communication system, an ACARS unit, a CPDLC system, FANS, and/or the like.

Using the ground system 120 and the ground wireless communications link 122, the various non-aircraft components depicted in the embodiment of FIG. 1 may be communicatively coupled to the aircraft 130, even in instances where the aircraft 130 is airborne and in flight, thereby allowing for on-demand transmission of software and/or software updates whenever such software and/or software updates may be needed. However, it should be understood that the embodiment depicted in FIG. 1 is merely illustrative. In other embodiments, the aircraft 130 may be communicatively coupled to the various other components of the access control system 100 when on the ground and physically coupled to one of the components of the access control system 100, such as, for example, the GSE 170.

The GSE 170 is an equipment external equipment used to support and test the engine control system 136 and/or other components of the aircraft 102. The GSE 170 is configured to provide software updates to the engine control system 136 and download data obtained by the engine control system 136 during a flight. As another non-limiting example, the GSE 170 may include production support equipment for restricted data monitoring, test support equipment for comprehensive data monitoring and changing adjustable parameters, and integration test rigs for system and software testing. In embodiments, the GSE 170 may be connected to the engine control system 136 via wired local area network, or Ethernet. The GSE 170 may communicate with the engine control system 136 according to Ethernet protocols. The GSE 170 may be a portable maintenance access terminal. The GSE 170 may test a ballistic mode of the aircraft by directly communicating with a control unit.

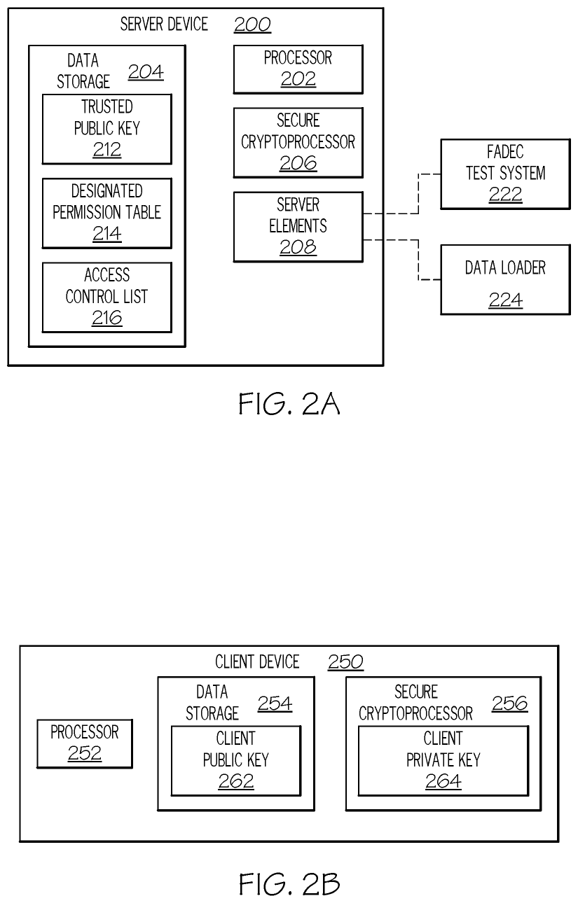

FIG. 2a depicts a block diagram of a server device, according to one or more embodiments shown and described herein. As shown, a server device 200 includes a processor 202, a data storage 204, and a secure cryptoprocessor 206. In an embodiment, server device 200 takes the form of the engine control system 136 shown in FIG. 1. Processor 202 and data storage 204 could take the form of the processor 162 and the non-transitory memory component 164, respectively. Secure cryptoprocessor 206 could take the form of a trusted platform module (TPM) of the server device, among other examples.

It should be understood that server device 200 could take other forms as well, such as a FADEC system, an EEC, an ECU, or any combination of these, among other possibilities. In some embodiments, server device 200 may include different and/or additional components. For instance, some embodiments of server device 200 do not include secure cryptoprocessor 206. Additionally, server device 200 could take the form of multiple server devices.

Data storage 204 includes a trusted public key 212, which could take the form of a public key that is associated with a private key that, together with the public key, forms a public-private key pair. The public key and private key may be cryptographic keys generated according to an asymmetric key algorithm. The asymmetric key algorithm may be based on mathematical problems that form the basis for a one-way function. An example of such a mathematical problem is the discrete logarithm problem: computing a discrete exponentiation based on one or more large prime numbers may be relatively easy, while computing the inverse of the discrete exponentiation (i.e., the discrete logarithm) may be relatively difficult. Examples of asymmetric key algorithms include the Rivest-Shamir-Adleman (RSA) algorithm and the Digital Signature Algorithm (DSA) algorithm.

In some embodiments, trusted public key 212 is deployed to server device 200 by a manufacturer during production of the server device—for instance, to prevent tampering of the trusted public key prior to deployment of the trusted public key to data storage 204. As another possibility, a public key received by server device 200 could be saved to data storage 204 as trusted public key 212—for example, if the server device confirms the identity of a source that generated the received public key and validates an integrity of the received public key (e.g., to ensure there was no tampering of the public key after the public key was generated by the source but before the public key was received by the server device). Other examples are possible as well.

Data storage 204 further includes a designated permission table 214 and an access control list 216. Additionally, as shown in FIG. 2a, server device 200 further includes server elements 208, which could take the form of respective hardware components or software programs, as examples. In the illustrated embodiment, server elements 208 that communicate with various client devices such as, for example, a FADEC test system 222 and a data loader 224, though it should be understood that server elements 208 may include additional and/or different server elements. Additional details regarding these aspects are provided below.

FIG. 2b depicts a block diagram of a client device, according to one or more embodiments shown and described herein. The client device may be, for example, the FADEC test system 222 or the data loader 224 depicted in FIG. 2a. However, it should be understood that other client devices are also contemplated and included within the scope of the present disclosure. As shown, a client device 250 include a processor 252, a data storage 254, and secure cryptoprocessor 256. In an embodiment, client device 250 takes the form of GSE 170 shown in FIG. 1. Processor 252 and data storage 254 could take the form of the one or more processing devices 172 and the non-transitory memory component 174 of GSE 170, respectively, and secure cryptoprocessor 256 could take a form similar to secure cryptoprocessor 206 of server device 200, among other possibilities. For instance, secure cryptoprocessor 256 could take the form of a TPM of client device 250. It should be understood that client device 250 could take other forms as well, and could take the form of multiple client devices. Furthermore, client device 250 may include different and/or additional components. In some embodiments, secure cryptoprocessor 256 takes the form of a smartcard provided to client device 250 and/or a hardware security module communicatively connected to the client device.

Data storage 254 includes a client public key 262, and secure cryptoprocessor 256 includes a client private key 264 that is associated with client public key 262. Client public key 262 and client private key 264 are cryptographic keys generated according to an asymmetric key algorithm such as the asymmetric key algorithms described above with respect to FIG. 2a. It should be understood that client private key 264 need not be stored in a secure cryptoprocessor such as secure cryptoprocessor 256, and that client public key 262 could be stored in secure cryptoprocessor 256 (in addition to or instead of data storage 254).

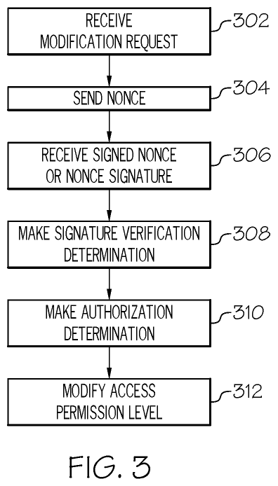

FIG. 3 depicts a flowchart of a method carried out by server device 200, according to one or more embodiments shown and described herein. As shown, a method 300 begins at step 302 with server device 200 receiving a modification request from client device 250 to modify a respective access permission level, designated to the client device for a target server element among server elements 208, from a baseline permission level among a permission hierarchy of access permission levels to an elevated permission level among the permission hierarchy. The modification request could include an identification of the elevated permission level or the baseline permission level.

As used herein, modifying an access permissions level means that the access permissions level is either escalated or de-escalated. As such, when modified, the access permissions level may be escalated according to a request or may be de-escalated according to a request, which results in a different permissions level.

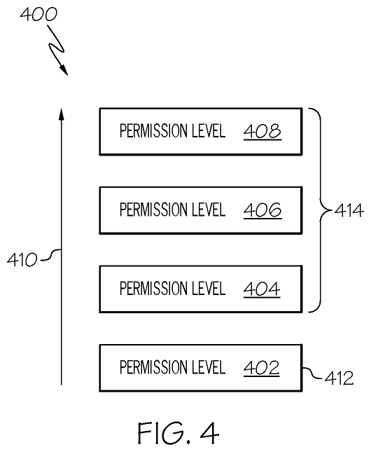

FIG. 4 depicts a permission hierarchy of access permission levels, according to one or more embodiments shown and described herein. As shown, a permission hierarchy 400 includes access permission levels 402, 404, 406, and 408. The access permission levels of permission hierarchy 400 could take the form of (or include), for example, no access, read restricted data, read any data, change FMBUS and wildcard lists, write adjustments, write any data, a parameter simulation data storage to RAM, or any combination of these or other access permission levels.

Also shown in FIG. 4 is an axis 410 that indicates access permission levels of increasingly higher permission levels among permission hierarchy 400. As illustrated, access permission level 404 is a higher permission level than access permission level 402, but a lower permission level than access permission levels 406 and 408. Access permission level 406 is a higher permission level than access permission levels 402 and 404, but a lower permission level than access permission level 408. With respect to access permission level 408, none of the other access permission levels in permission hierarchy 400 are higher permission levels, and with respect to access permission level 402, none of the other access permission levels in permission hierarchy 400 are lower permission levels. Server device 200 may designate a respective access permission level among permission hierarchy 400 to each of one or more client devices for each of one or more server elements 208.

FIG. 4 further depicts an example of a baseline permission level 412 and elevated permission levels 414, shown as access permission level 402 and access permission levels 404, 406, and 408, respectively. Each of access permission levels 404, 406, and 408 are higher permission levels than access permission level 402, and are thus elevated permission levels with respect to the baseline permission level. Though FIG. 4 depicts access permission level 402 as a baseline permission level, it should be understood that other access permission levels in permission hierarchy 400 could take the form of a baseline permission level. For example, access permission level 404 could be a baseline permission level. In such an example, access permission levels 406 and 408 would take the form of elevated permission levels, since these access permission levels are higher permission levels than access permission level 404.

Each access permission level in permission hierarchy 400 may be associated with a respectively different numeric permission level. Each respective access permission level is a higher permission level among the permission hierarchy than access permission levels associated with respective numeric permission levels that are numerically less that the respective numeric permission level associated with the respective access permission level.

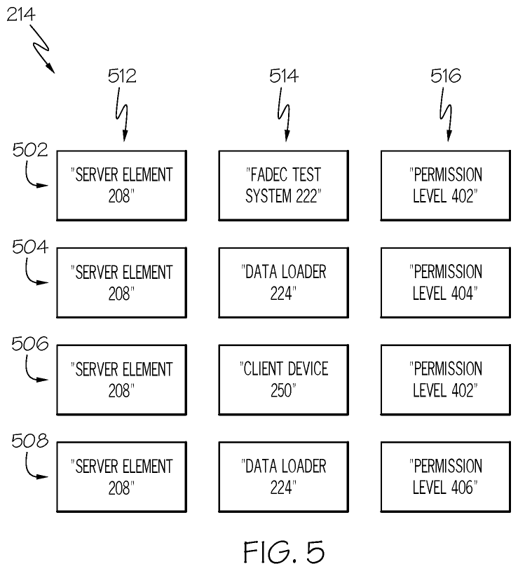

FIG. 5 depicts a designated permission table, according to one or more embodiments shown and described herein. As shown, designated permission table 214 includes permission level designations 502, 504, 506, and 508. Each of the permission level designations includes a respective identifier 512 of a respective server element among server elements 208, and a respective identifier 514 of a respective client device (which could be client device 250 or another client device). Each of the permission level designations further includes a respective identifier 516 of a respective access permission level (among permission hierarchy 400) designated to the respective client device identified by identifier 514 for the respective server element identified by identifier 512.

For instance, in permission level designation 502 illustrated in FIG. 5, identifier 512 identifies the respective server element, and identifier 514 identifies the client device as the FADEC test system 222. Identifier 516 identifies access permission level 402 as the respective access permission level designated to the respective client device for the respective server element identified by identifiers 514 and 512, respectively. In other words, permission level designation 502 indicates that access permission level 402 is designated to the FADEC test system 222 for the server element 208. Similarly, permission level designation 504 indicates that access permission level 402 is designated to the data loader 224 for the server element. Likewise, permission level designation 506 indicates that access permission level is designated to a client device 250 (other than the FADEC test system 222) for a server element 208, and permission level designation 508 indicates that access permission level 406 is designated to client device 250 for a server element 208.

It should be understood that identifier 514 need not uniquely identify client device 250 or any other client device. For instance, identifier 514 could identify client device 250 by identifying a certificate of a certificate authority (CA) in a public key infrastructure (PKI). For instance, identifier 514 could identify a CA certificate (such as a root CA certificate or an intermediate CA certificate, or could identify the respective public key of the certificate). Respective client certificates for client devices (such as client device 250) may be signed by the certificate authority using such the CA certificate, and respective client devices may be identified based on an identifier of the CA certificate that signed the client certificates.

In an embodiment, prior to receiving the modification request at step 302 shown in FIG. 3, server device 200 establishes a communication session with client device 250. The communication session could include communication via a datagram transport layer security (DTLS) session, a transport layer security (TLS) communication, a secure shell (SSH) session, or a combination of these, as examples. In such an embodiment, receiving the modification request from client device 250 may include receiving the modification request via the communication session with the client device. In some embodiments, the respective access permission level designated to client device 250 is a respective access permission level designated to the communication session with the client device. In such embodiments, the request to modify the respective access permission level designated to client device 250, received by server device 200 at step 302, includes a request to modify the respective access permission level designated to the communication session with the client device.

Prior to or subsequent to receiving the modification request at step 302, server device 200 may designate the baseline permission level among permission hierarchy 400 as the respective access permission level designated to client device 250 for the target server element. For example, designating the baseline permission level may include designating the baseline permission level as the respective access permission designated to a communication session with client device 250. Server device 200 may establish the communication session prior to receiving the modification request at step 302, and in response to establishing the communication session, may designate the baseline permission level as the respective access permission designated to the communication. Subsequently, server device 200 may receive the modification request from client device 250 via the communication session.

As another example, designating the baseline permission level may include designating the baseline permission level to one or more of a plurality of devices that includes client device 250—for instance, a plurality of devices that includes client device 250 and client device 250, as shown in designated permission table 214. In this example, server device 200 may designate the baseline permission level prior to receiving the modification request from client device 250, or may designate the baseline permission level subsequent to (e.g., in response to) receiving the modification request.

Referring again to FIG. 3, at step 304, server device 200 sends a nonce associated with the modification request to client device 250, and at step 306, server device 200 receives a signed nonce or nonce signature generated by client device 250 based on both the nonce and client private key 264 (of client device 250, as discussed above with reference to FIG. 2b).

Sending the nonce could include server device 200 generating the nonce and sending the generated nonce to client device 250. The nonce could take the form of a number, such as a random number and/or a pseudorandom number, and generating the nonce could include server device 200 generating the random number and/or pseudorandom number. Sending the nonce to client device 250 could include, for instance, server device 200 sending the nonce via a communication session with the client device. The signed nonce or nonce signature is subsequently received from client device 250—e.g., via the communication session with client device 250.

At step 308, server device 200 makes a signature verification determination of an authenticity of the received signed nonce or nonce signature based on client public key 262, which is discussed above with reference FIG. 2a. Client public key 262 is associated with client private key 264, and is trusted by server device 200.

The signature verification determination may be based on a public key infrastructure that includes a CA—for instance, as part of a PKI. For instance, a root CA certificate or an intermediate CA certificate (or the respective public keys of the certificates) could be stored as trusted public key 212 in data storage 204 of server device 200, which is depicted in FIG. 2a. Server device 200 may determine an authenticity of client public key 262 based on trusted public key 212, and if the client public key is authentic, may determine an authenticity of the received signed nonce or nonce signature based on the client public key.

To illustrate, in an embodiment, client public key 262 and a client-certificate signature (e.g., generated by a certificate authority) collectively form a client certificate. In this embodiment, client public key 262 may be trusted by server device 200, for example, because the client certificate is trusted by the server device (perhaps because the certificate authority that generated the client-certificate signature is trusted).

In one such embodiment, the client-certificate signature of the client certificate is generated by a certificate authority based on both client public key 262 and a CA private key of the certificate authority. The CA private key is associated with a CA public key that is trusted by server device 200. In such an embodiment, the client certificate may be trusted by server device 200, for example, because the CA public key is trusted by the server device. In some embodiments, the CA public key is included in a CA certificate that is trusted by server device 200, and the CA public key may be trusted by server device 200, for example, because the CA certificate is trusted by the server device.

In an embodiment of the above, the CA certificate in turn includes a CA signature generated based on the CA public key and a signing private key. As one example, the signing private key may be the CA private key, and the CA certificate may take the form of a root CA certificate. As another example, the CA certificate may take the form of an intermediate CA certificate, and the signing private key may be a root CA private key. The root CA private key is associated with a root CA public key, and the root CA public key may be trusted by server device. In such an example, the CA certificate may be trusted by server device 200 because the root CA public key is trusted.

The root CA public key may be included in a root CA certificate that is trusted by server device 200. In an embodiment, the root CA public key is trusted because the root CA certificate is trusted. Any one or more of the client certificate, the CA certificate, the intermediate CA certificate, and the root CA certificate could take the form of respective public key certificates, such as X.509 certificates.

At step 310, server device 200 makes an authorization determination that client device 250 is authorized for the requested permission level for the target server element. Making the authorization determination may include determining that the requested elevated permission level is no more than an authorized permission level assigned to client device 250 for the target server element, which in turn could include determining that an access control list includes an assignment of the authorized permission level to client device 250 for the target server element. The access control list could take the form of access control list 216 stored in data storage 204 of server device 200.

For instance, access control list 216 could assign access permission level 406 as the authorized permission level assigned to the FADEC test system 222. Server device 200 may accordingly determine that access permission level 406 is the authorized permission level based on access control list 216. In such case, the authorization determination may be made by server device 200 if the requested elevated permission level for FADEC test system 222 for server element 208 is access permission level 402, 404, or 406. Conversely, the authorization determination is not made if the requested elevated permission is access permission level 408.

At step 312, in response to making both the signature verification determination at step 308 and the authorization determination at step 310, server device 200 modifies the respective access permission level designated to client device 250 for the target server element from the baseline permission level to the requested permission level. For example, the access permission level may be escalated or de-escalated.

Modifying the respective access permission level may allow client device 250 to perform (or request performance of) a given operation on the target server device. The given operation could include: reading from the server device, writing to the server device, updating software that is stored on the target server device and that is executable by the server device, updating a firmware that is stored on the target server device and that is executable by the server device, or any combination of these or other operations.

If client device 250 requests performance of a given operation on a given server element, server device 200 may determine whether the access permission level designated to the client device for the given server element is at least a required permission level for performing the given operation of the given server device. As an example, access permission level 206 may be required in order to allow the FADEC test system 222 to write to the server device 200. In one scenario, prior to server device 200 modifying the respective access permission level designated to the FADEC test system 222 for the respective server element 208, the respective access permission level is access permission level 402. If the FADEC test system 222 were to request a write to the server device 200 in this scenario, then server device 200 may deny the request to perform the operation, since respective access permission level (i.e., access permission level 402) is less than the required access permission level for the FADEC test system 222 to write to the server device 200 (i.e., access permission level 406). In another scenario, as a result of server device 200 modifying the respective access permission level designated to the FADEC test system 222 for the respective server element 208, the respective access permission level is access permission level 406. If the FADEC test system 222 were to request a write to the server device 200 in this other scenario, then server device 200 may allow the request to perform the operation, since respective access permission level (i.e., access permission level 406) is at least the required access permission level for the FADEC test system 222 to write to the server device 200 (i.e., access permission level 406).

In an embodiment, subsequent to a requested performance of a given operation on a target server device 200 by client device 250, server device 200 modifies the access permission level designated to client device 250 for the respective target server element from the elevated permission level to the baseline permission level. For example, server device 200 may make a timeout determination that no operation requests to perform operations on the target server element were received during a preceding timeout period. In some embodiments, server device 200 makes the timeout determination subsequent to receiving the operation request and while the respective access permission level designated to client device 250 for the target server element is the elevated permission level. The timeout period could be, for instance, a given period of time subsequent to receiving the operation request and/or a given period of time subsequent to allowing the requested performance. In response to making the timeout determination, server device 200 may modify the respective access permission level designated to client device 250 for the target server element from the elevated permission level to the baseline permission level. Accordingly, the designated access permission level need only be modified during performance of the given operation.

It should now be understood that that devices, systems, and methods described herein utilize trusted cryptographic keys to authenticate a client device and modify an access permission level designated to the client device. The trusted cryptographic keys obviate the need to manage the passwords of numerous client devices.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

Further aspects of the invention are provided by the subject matter of the following clauses:

A method is carried out by a server device that includes one or more server elements. The method includes receiving a modification request from a client device to modify a respective access permission level, designated to the client device for a target server element among the server elements, from a baseline permission level among a permission hierarchy of access permission levels to a different permission level among the permission hierarchy. The method further includes sending a nonce associated with the modification request to the client device, and receiving a signed nonce or nonce signature generated by the client device based on both the nonce and a client private key of the client device. The method also includes making a signature verification determination of an authenticity of the received signed nonce or nonce signature based on a client public key that is both associated with the client private key and trusted by the server device. Additionally, the method includes making an authorization determination that the client device is authorized for the requested permission level for the target server element. The method further includes, in response to making both the signature verification determination and the authorization determination, modifying the respective access permission level designated to the client device for the target server element from the baseline permission level to the requested permission level.

The method of any preceding clause, wherein the target server element comprises at least one of a server communicating with a full authority digital engine control (FADEC) test system and a server communicating with a data loader

The method of any preceding clause, wherein the access permission levels among the permission hierarchy comprise one or more of negotiation of access permissions, read restricted data, read any data, change FMBUS and wildcard lists, write adjustments, write any data, and a parameter simulation data storage to random access memory (RAM).

The method of any preceding clause, wherein each access permission level in the permission hierarchy is associated with a respectively different numeric permission level, and wherein each respective access permission level is a higher permission level among the permission hierarchy than access permission levels associated with numeric permission levels that are numerically less that the respective numeric permission level associated with the respective access permission level.

The method of any preceding clause, further comprising: prior to receiving the modification request, establishing a communication session with the client device, wherein the respective access permission level designated to the client device for the target server element comprises a respective access permission level designated to the communication session for the target server element.

The method of any preceding clause, wherein the communication session comprises communication via at least one of a datagram transport layer security (DTLS) session, a transport layer security (TLS) communication, and a secure shell (SSH) session.

The method of any preceding clause, further comprising: subsequent to establishing the communication session, designating the baseline permission level as the respective access permission level designated to the communication session for the target server element.

The method of any preceding clause, further comprising: prior to receiving the modification request, designating the baseline permission level as the respective access permission level designated to one or more of a plurality of devices that includes the client device for one or more of the server elements.

The method of any preceding clause, wherein the nonce comprises at least one of a random number and a pseudorandom number.

The method of any preceding clause, wherein the client public key and a client-certificate signature collectively form a client certificate, wherein the client-certificate signature of the client certificate is generated by a certificate authority based on both the client public key and a certificate authority (CA) private key of a certificate authority, and wherein making the signature verification determination comprises determining the authenticity of the received signed nonce or nonce signature based on a CA public key that is both associated with the CA private key and trusted by the server device.

The method of any preceding clause, wherein the client certificate comprises an X.509 certificate.

The method of any preceding clause, wherein making the authorization determination comprises determining that elevated permission is no more than an authorized permission level assigned to the client device for the target server element.

A server device includes one or more server elements, a processor, and a non-transitory computer-readable storage medium that includes one or more of instructions and data. The instructions, when executed by the processor, cause the server device to receive a modification request from a client device to modify a respective access permission level, designated to the client device for a target server element among the server elements, from a baseline permission level among a permission hierarchy of access permission levels to a different permission level among the permission hierarchy. The instructions further cause the server device to send a nonce associated with the modification request to the client device, and receive a signed nonce or nonce signature generated by the client device based on both the nonce and a client private key of the client device. The instructions also cause the server device to make a signature verification determination of an authenticity of the received signed nonce or nonce signature based on a client public key that is both associated with the client private key and trusted by the server device. Additionally, the instructions cause the server device to make an authorization determination that the client device is authorized for the requested permission level for the target server element. The instructions further cause the server device to, in response to making both the signature verification determination and the authorization determination, modify the respective access permission level designated to the client device for the target server element from the baseline permission level to the requested permission level.

The server device of any preceding clause, wherein each access permission level in the permission hierarchy is associated with a respectively different numeric permission level, and wherein each respective access permission level is a higher permission level among the permission hierarchy than access permission levels associated with numeric permission levels that are numerically less that the respective numeric permission level associated with the respective access permission level.

The server device of any preceding clause, wherein the instructions further cause the server device to establish a communication session with the client device prior to receiving the modification request, and wherein the respective access permission level designated to the client device for the target server element comprises a respective access permission level designated to the communication session for the target server element.

The server device of any preceding clause, wherein the communication session comprises communication via at least one of a datagram transport layer security (DTLS) session, a transport layer security (TLS) communication, and a secure shell (SSH) session.

The server device of any preceding clause, wherein the instructions further cause the server device to, subsequent to establishing the communication session, designate the baseline permission level as the respective access permission level designated to the communication session for the target server element.

The server device of any preceding clause, wherein the client public key and a client-certificate signature collectively form a client certificate, wherein the client-certificate signature of the client certificate is generated by a certificate authority based on both the client public key and a certificate authority (CA) private key of a certificate authority, and wherein the instructions to make the signature verification determination comprise instructions that cause the server device to determine the authenticity of the received signed nonce or nonce signature based on a CA public key that is both associated with the CA private key and trusted by the server device.

The server device of any preceding clause, wherein the client certificate comprises an X.509 certificate.

The server device of any preceding clause, wherein the instructions to make the authorization determination comprise instructions that cause the server device to determine that elevated permission is no more than an authorized permission level assigned to the client device for the target server element.

A method is carried out by a server device that includes one or more server elements. The method includes establishing a communication session with a client device. The method further includes receiving, via the communication session, a modification request from a client device to modify a respective access permission level, designated to the client device for a target server element among the server elements, from a baseline permission level among a permission hierarchy of access permission levels to a different permission level among the permission hierarchy. The method further includes sending a nonce associated with the modification request to the client device, and receiving a signed nonce or nonce signature generated by the client device based on both the nonce and a client private key of the client device. The method also includes making a signature verification determination of an authenticity of the received signed nonce or nonce signature based on a client public key that is both associated with the client private key and trusted by the server device. Additionally, the method includes making an authorization determination that the client device is authorized for the requested permission level for the target server element. The method further includes, in response to making both the signature verification determination and the authorization determination, modifying the respective access permission level designated to the client device for the target server element from the baseline permission level to the requested permission level. The method includes receiving, from the client device, an operation request to perform a given operation on the target server device, and making a permission determination that the respective access permission level designated to the client device for the target server element is no less than a required permission level for performing the given operation on the target server device. The method additionally includes, in response to making the permission determination, allowing performance of the given operation on the target server device.

The method of any preceding clause, wherein the given operation comprises at least one of: reading from the server device, writing to the server device, updating a software that is stored on the target server device and that is executable by the server device, and updating a firmware that is stored on the target server device and that is executable by the server device.

The method of any preceding clause, wherein the target server element comprises at least one of a server that communicates with a full authority digital engine control (FADEC) test system and a server that communicates with a data loader.

The method of any preceding clause, wherein the access permission levels among the permission hierarchy comprise one or more of access permissions negotiation only, read restricted data, read any data, change FMBUS and wildcard lists, write adjustments, write any data, and a parameter simulation data storage to random access memory (RAM).

The method of any preceding clause, wherein the access permission levels among the permission hierarchy comprise one or more of access permissions negotiations only, download version information, download Non-Volatile Memory (NVM), upload Non-Volatile Memory (NVM), upload Programmable Read Only Memory (PROM) and Non-Volatile Memory (NVM), rekey.

The method of any preceding clause, wherein the communication session comprises communication via at least one of a datagram transport layer security (DTLS) session, a transport layer security (TLS) communication, and a secure shell (SSH) session.

The method of any preceding clause, further comprising: subsequent to receiving the operation request, and while the respective access permission level designated to the client device for the target server element is the elevated permission level, making a timeout determination that no operation requests to perform operations on the target server device were received during a preceding timeout period; and in response to making the timeout determination, modifying the respective access permission level designated to the client device for the target server element from the elevated permission level to the baseline permission level.

What is claimed is:

1. A method carried out by a server device comprising one or more server elements, the method comprising:
receiving a modification request from a client device to modify a respective access permission level, designated to the client device for a target server element among the server elements, from a baseline permission level among a permission hierarchy of access permission levels to a different permission level among the permission hierarchy;
sending a nonce associated with the modification request to the client device, and receiving a signed nonce or nonce signature generated by the client device based on both the nonce and a client private key of the client device;
making a signature verification determination of an authenticity of the received signed nonce or nonce signature based on a client public key that is both associated with the client private key and trusted by the server device;
making an authorization determination that the client device is authorized for the requested permission level for the target server element; and
in response to making both the signature verification determination and the authorization determination, modifying the respective access permission level designated to the client device for the target server element from the baseline permission level to the requested permission level.

2. The method of claim 1, wherein the client device is a full authority digital engine control (FADEC) test system or a data loader.

3. The method of claim 1, wherein the access permission levels among the permission hierarchy comprise one or more of access permissions negotiation, read restricted data, read any data, change FMBUS and wildcard lists, write adjustments, write any data, and a parameter simulation data storage to random access memory (RAM).

4. The method of claim 1, wherein the access permission levels among the permission hierarchy comprise one or more of access permissions negotiations, download version information, download Non-Volatile Memory (NVM), upload Non-Volatile Memory (NVM), upload Programmable Read Only Memory (PROM) and Non-Volatile Memory (NVM), rekey.

5. The method of claim 1, wherein:
each access permission level in the permission hierarchy is associated with a respectively different numeric permission level, and
each respective access permission level is a higher permission level among the permission hierarchy than access permission levels associated with numeric permission levels that are numerically less that the respective numeric permission level associated with the respective access permission level.

6. The method of claim 1, further comprising:
prior to receiving the modification request, establishing a communication session with the client device,
wherein the respective access permission level designated to the client device for the target server element comprises a respective access permission level designated to the communication session for the target server element.

7. The method of claim 6, wherein the communication session comprises communication via at least one of a datagram transport layer security (DTLS) session, a transport layer security (TLS) communication, and a secure shell (SSH) session.

8. The method of claim 6, further comprising:
subsequent to establishing the communication session, designating the baseline permission level as the respective access permission level designated to the communication session for the target server element.

9. The method of claim 1, further comprising:
prior to receiving the modification request, designating the baseline permission level as the respective access permission level designated to one or more of a plurality of devices that includes the client device for one or more of the server elements.

10. The method of claim 1, wherein:
the client public key and a client-certificate signature collectively form a client certificate,
the client-certificate signature of the client certificate is generated by a certificate authority based on both the client public key and a certificate authority (CA) private key of a certificate authority, and
making the signature verification determination comprises determining the authenticity of the received signed nonce or nonce signature based on a CA public key that is both associated with the CA private key and trusted by the server device.

11. The method of claim 1, wherein making the authorization determination comprises determining that elevated permission is no more than an authorized permission level assigned to the client device for the target server element.

12. A server device comprising:
one or more server elements;
a processor; and
a non-transitory computer-readable storage medium comprising instructions that, when executed by the processor, cause the server device to:
receive a modification request from a client device to modify a respective access permission level, designated to the client device for a target server element among the server elements, from a baseline permission level among a permission hierarchy of access permission levels to a different permission level among the permission hierarchy;
send a nonce associated with the modification request to the client device, and receive a signed nonce or nonce signature generated by the client device based on both the nonce and a client private key of the client device;
make a signature verification determination of an authenticity of the received signed nonce or nonce signature based on a client public key that is both associated with the client private key and trusted by the server device;
make an authorization determination that the client device is authorized for the requested permission level for the target server element; and
in response to making both the signature verification determination and the authorization determination, modify the respective access permission level designated to the client device for the target server element from the baseline permission level to the requested permission level.

13. The server device of claim 12, wherein:
each access permission level in the permission hierarchy is associated with a respectively different numeric permission level, and
each respective access permission level is a higher permission level among the permission hierarchy than access permission levels associated with numeric permission levels that are numerically less that the respective numeric permission level associated with the respective access permission level.

14. The server device of claim 12, wherein:
the client public key and a client-certificate signature collectively form a client certificate,
the client-certificate signature of the client certificate is generated by a certificate authority based on both the client public key and a certificate authority (CA) private key of a certificate authority, and
the instructions to make the signature verification determination comprise instructions that cause the server device to determine the authenticity of the received signed nonce or nonce signature based on a CA public key that is both associated with the CA private key and trusted by the server device.

15. A method carried out by a server device comprising one or more server elements, the method comprising:
establishing a communication session with a client device;
receiving, via the communication session, a modification request to modify a respective access permission level, designated to the client device for a target server element among the server elements, from a baseline permission level among a permission hierarchy of access permission levels to a different permission level among the permission hierarchy;
sending a nonce associated with the modification request to the client device via the communication session, and receiving, via the communication session, a signed nonce or nonce signature generated by the client device based on both the nonce and a client private key of the client device;
making a signature verification determination of an authenticity of the received signed nonce or nonce signature based on a client public key that is both associated with the client private key and trusted by the server device;
making an authorization determination that the client device is authorized for the requested permission level for the target server element; and
in response to making both the signature verification determination and the authorization determination, modifying the respective access permission level designated to the client device for the target server element from the baseline permission level to the requested permission level;
receiving, from the client device, an operation request to perform a given operation on the target server device;
making a permission determination that the respective access permission level designated to the client device for the target server element is no less than a required permission level for performing the given operation on the target server device; and
in response to making the permission determination, allowing performance of the given operation on the target server device.

16. The method of claim 15, wherein the given operation comprises at least one of: reading from the server device, writing to the server device, updating a software that is stored on the target server device and that is executable by the server device, and updating a firmware that is stored on the target server device and that is executable by the server device.

17. The method of claim 15, wherein the client device is a full authority digital engine control (FADEC) test system or a data loader.

18. The method of claim 15, wherein the access permission levels among the permission hierarchy comprise one or more of access permissions negotiation, read restricted data, read any data, change FMBUS and wildcard lists, write adjustments, write any data, and a parameter simulation data storage to random access memory (RAM).

19. The method of claim 15, wherein the access permission levels among the permission hierarchy comprise one or more of access permissions negotiations, download version information, download Non-Volatile Memory (NVM), upload Non-Volatile Memory (NVM), upload Programmable Read Only Memory (PROM) and Non-Volatile Memory (NVM), rekey.

20. The method of claim 15, further comprising:
subsequent to receiving the operation request, and while the respective access permission level designated to the client device for the target server element is the elevated permission level, making a timeout determination that no operation requests to perform operations on the target server device were received during a preceding timeout period; and
in response to making the timeout determination, modifying the respective access permission level designated to the client device for the target server element from the elevated permission level to the baseline permission level.
